(19) United States
(12) Patent Application Publication
(10) Pub. No.: US 2007/0025742 A1
(43) Pub. Date: Feb. 1, 2007

(54) Light modifier with spiral optical forms

(76) Inventors: Michael Callahan, New York, NY (US); Dennis J. Solomon, New York, NY (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 11/351,068

(22) Filed: Feb. 9, 2006

Related U.S. Application Data
(60) Provisional application No. 60/651,378, filed on Feb. 9, 2005.

(51) Int. Cl. G03G 15/00

(52) U.S. Cl. 399/6

(57) ABSTRACT

Improvements to light equipment are disclosed, including modular constructions of both lighting fixtures and of units for distribution and, if desired, dimming.

The application claims priority to U.S. application Ser. No. 60/651,307, the entire disclosure of which is hereby incorporated by reference.

### BRIEF DESCRIPTION OF THE INVENTION

This application relates to various improvements to lighting equipment and systems.

### BRIEF DESCRIPTION OF THE DRAWINGS

FIG. 1 illustrates a family of modular components that can be assembled to produce lighting fixtures having various features and capabilities.

FIG. 5 illustrates a color or effects wheel for a lighting fixture accepting a variety of different components to serve a variety of different functions.

FIG. 11 is an end elevation of a truss.

FIG. 12 is a section through one embodiment of a lighting fixture/assembly having a portion, including the light source and associated optics, that retracts and extends in and out of another portion.

FIG. 13 is a view from outside of a truss structure showing a lighting fixture/assembly within it, retracted within such truss structure.

FIG. 14 is a side elevation/section showing the lighting fixture/assembly of the prior Figures installed within a truss structure, the view being from a perspective at right angles to both the elongated axis of the truss and the axis through which the fixture head is extended from the retracted position illustrated to an extended position.

FIG. 15 is a sectional view equivalent to FIG. 12 through the truss structure, with multiple such fixture assemblies installed, illustrating different alternatives for their attachment to the truss structure and for the mounting of modules containing additional components.

FIG. 16 is a view from an external perspective that is opposite that of FIG. 13, illustrating methods of mounting the fixture assembly in a truss structure.

FIG. 17 is a sectional view similar to FIG. 15, illustrating another design for modules containing additional components.

FIG. 18 is a view, from a similar perspective as FIG. 14, illustrating the module design of the previous Figure.

FIG. 20 illustrates a base unit for distribution of power to loads as well as additional enclosures capable of cooperating with it to include or accept dimming power stages.

FIG. 21 illustrates a base unit designed to accept a plurality of output modules, each such module providing for different output connections.

FIG. 22 illustrates a base unit designed to accept a plurality of output modules having different output connections.

FIG. 23 illustrates a base unit designed to accept a plurality of output modules having different output connections, separate such modules providing for multi-circuit connections.

FIG. 24 illustrates a base unit designed to accept at least one output module having different output connections.

FIG. 25 illustrates a unit designed to accept a plurality of dimming power stage modules.

FIG. 26A illustrates a base unit accepting a power input via single-pole connectors and providing power outputs by single-pole connectors.

FIG. 26B illustrates a base unit accepting a power input via a multi-conductor cord set and a cable strain relief clamp therefore, and also providing power outputs via single-circuit receptacles.

FIG. 26C illustrates a base unit accepting a power input via single-pole connectors and power outputs via single pole connectors, both different than those illustrated in FIG. 26A.

FIG. 26D illustrates a plug-in output module, such as illustrated in prior Figures, and which may include a different type of output receptacle than that provided on the base unit.

FIG. 26E illustrates a plug-in output module such as illustrated in prior Figures, and including both single-circuit and multi-circuit output receptacles.

FIG. 26F illustrates a plug-in output module such as illustrated in prior Figures.

FIG. 27A is a plan view of one embodiment of a unit that engages an elongated busway for input power, and includes a section of that elongated busway.

FIG. 27A is a rear elevation of the unit in the prior Figure illustrating a connector used to engage the elongated busway.

FIG. 28A is a section through a fully enclosed busway.

FIG. 28B is an elevation of a fully enclosed busway, such as that of the prior Figure.

FIG. 28C is a unit engaged with the fully enclosed busway of the prior Figures.

FIG. 28D is a rear elevation of the unit of the previous Figure, illustrating a connector used to engage the fully enclosed busway of the prior Figures.

FIG. 28E is an exploded plan view of the unit of the prior two Figures and a section through the fully enclosed busway of the prior four Figures, illustrating a plug-in output module that makes some connections to the unit and others directly to the fully enclosed busway.

FIG. 28F is the plan view of the prior Figure with the components assembled.

FIG. 28G in a partial elevation of a method of fabricating a bus having internal recesses.

FIG. 28H is a partial elevation of another method of fabricating a bus having internal recesses, illustrating three such buses in offset relationship.

FIG. 29 illustrates one embodiment of a chassis receiving plug-in dimmer power stage modules.

FIG. 30 illustrates a base unit and an additional enclosure capable of cooperating with it to accept dimming power stages and further illustrates options for packaging control interfaces.

### DETAILED DESCRIPTION OF THE INVENTION

Some of the disclosed improvements relate to lighting fixtures.

A prior application to the same applicant describes improvements in which different types of light source can be readily exchanged in a fixture.

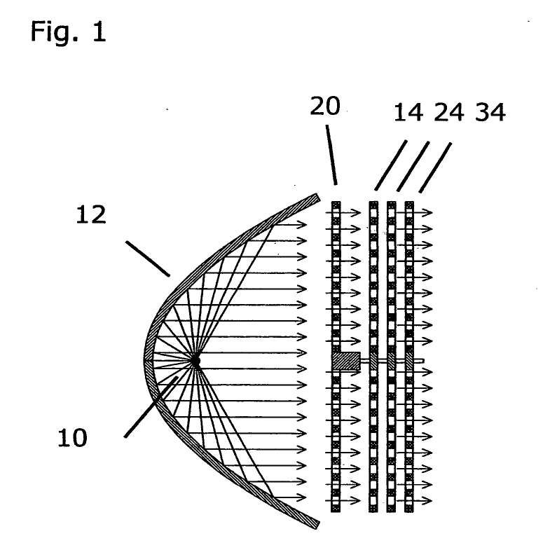

FIG. 1 is a flow chart of a highly modular family of lighting fixtures.

A common “back”, typically comprising at least a reflector, can be used with one or more of several different types of light sources (e.g., halogen and various discharge sources). Changes in the socket/“burner assembly” might be made necessary for different source types by different base designs and light-center-lengths or, as taught in the prior application, a common base/“burner assembly” might be employed. Different ballasts and igniters may be employed for each type of discharge source, and/or a ballast/igniter capable of operating multiple source types employed. Halogen light sources can be un-dimmed; dimmed by a remotely-located dimmer; or by a local dimmer. A ballast may be designed that is also capable of dimming halogen sources.

Similarly, power supply for local electronics and actuators can be provided by a separate power supply(s), whether local or remote; by a ballast designed with power supply output(s) for these purposes in addition to its lamp power output; by extracting power from the output of a remote dimmer; and/or by tapping/adapting the power supplied to discharge sources by a ballast.

Such ballasts/power supplies/dimmers can be made mechanically modular.

As is also illustrated by FIG. 1, the system can employ common or specialist lamphouse components with a variety of fixture types; of beam-modification accessories; and can be mechanized or not mechanized for remote pan and tilt, either with relatively low-cost actuators for economical remote focus, or more capable actuators and controls for fully-automated operation.

The power-supply requirements for the different variants will differ and can be provided by any one of the methods described.

The fixture “head” can be mounted in a conventional, un-motorized yoke, or in a motorized yoke that can be directly mounted to a base or clamp; to an “upper enclosure” that accommodates ballasts and power supplies; or to the “jack-in-the-truss” package disclosed in the prior application.

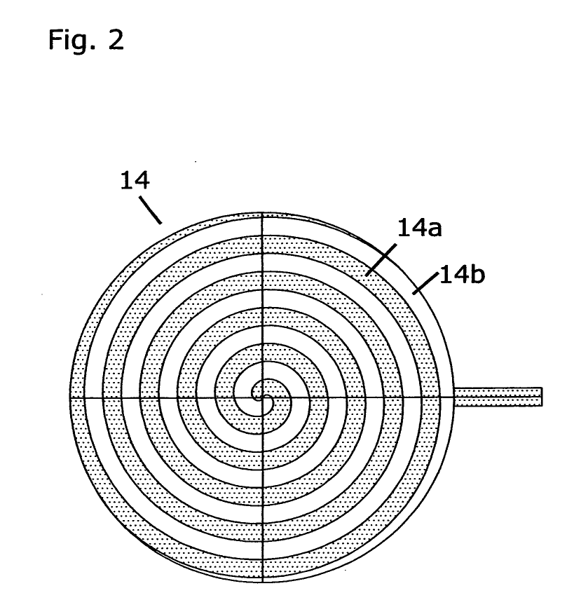

Another modular approach is illustrated in FIG. 5. Various types of beam-modifying mechanisms are known that employ discs or wheels. FIG. 5 illustrates a modular system that allows the insertion of a plurality of segments in a common hub (or, in an alternative embodiment, rim) to assemble a variety of such mechanisms.

Additional Figures relate to the “jack-in-the-truss” fixture packaging illustrated in FIGS. 4X-4X of the prior application.

In such packaging, a fixture is designed to be accommodated within the envelope defined by the structure of standard (typically square or rectangular) truss for shipping, and to extend beyond that envelope for use, by manual or motorized means.

The basic embodiment illustrated in the prior application was illustrated as generally rectangular in horizontal section, and sized to permit access to all four elongated chords of the truss structure for the attachment of other lighting and rigging equipment.

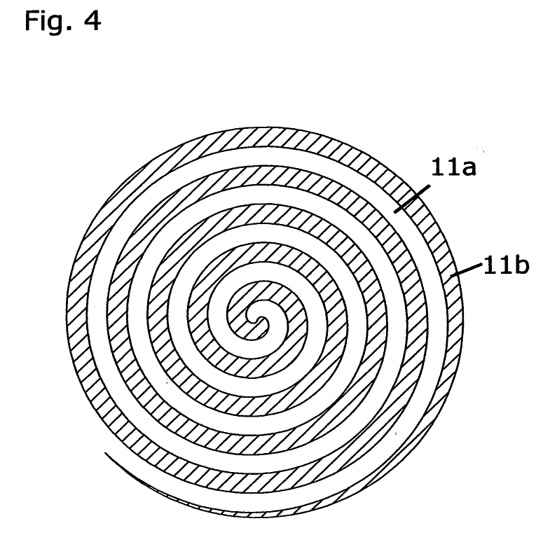

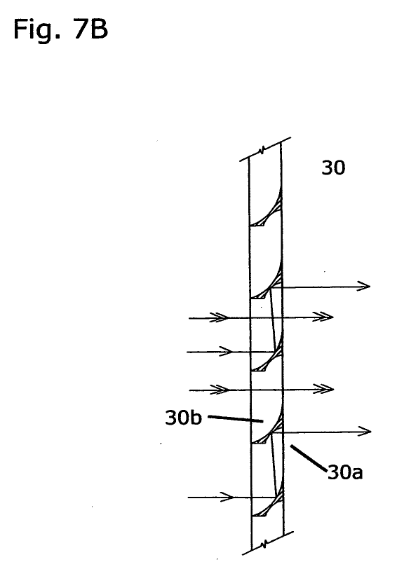

FIGS. 12-18 illustrate certain variations having some advantages.

Many such trusses are joined into longer spans by bolt plates or brackets at the section ends. The detail used (typically machined lengths of extruded angle) tends to obstruct all but the central portion of truss members framing the section end, and requires access into the volume defined by the truss to insert and remove the joining bolts.

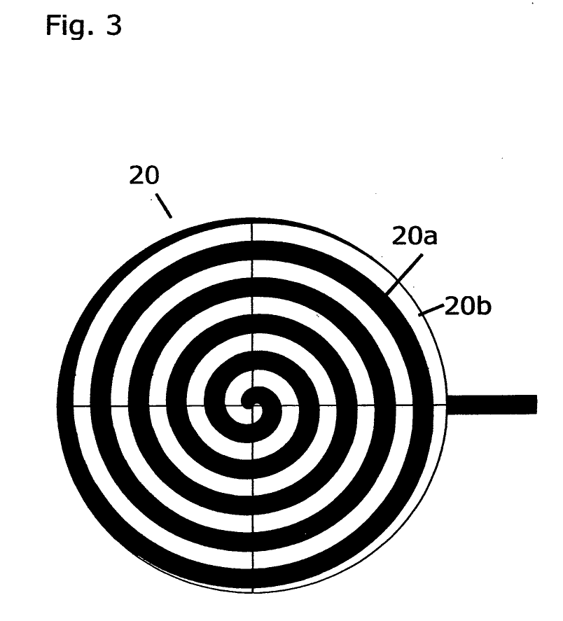

FIG. 11 illustrates a typical such truss section end of bolt-joined 20.5″ truss.

The generally rectangular enclosure section and the simple version of mounting brackets illustrated in the prior application might limit, particularly in truss sections of 4′ and 8′ lengths (whose transverse members are on closer centers than 5′ and 10′ sections), the use of that embodiment in the first and last “bay” of such sections, both insofar as they might restrict the access required for bolting and/or the simple mounting bracket illustrated might not be able to engage the end of a section because of conflict with the plates/angles used for the joining detail.

Independently, a fixture in this format will typically have the need for various electronic subsystems including power supplies; actuator drives; communications interfaces; and/or a local ballast or. dimmer.

Such subsystems will require packaging to permit ready field or shop replacement of failed subsystems—as well as changes in fixture configuration as required by different combinations of light source; fixture head; and/or parameter-modifying mechanisms.

The enclosed Figures illustrate several variations in packaging.

FIGS. 12-18 illustrate one possible variation in enclosure design. Enclosure 450 is illustrated as generally hexagon in horizontal section. As seen in FIG. 12, such a shape accommodates the bearings/rings like 466 on which the telescoping yoke assembly (e.g., 461-464) rotates. (A generally circular/cylindrical enclosure cross-section could also be used). Either form will have advantages as illustrated in subsequent Figures. Various electronic subassemblies can be packaged in elongated forms like 455, that are generally triangular in horizontal section and that mechanically engage enclosure 450 and are electrically connected to or via it. Electronics in such packages can be readily added and removed, both for configuration and service purposes. Un-hatched outlines also indicate additional or alternative mounting locations that still fall within the general truss envelope. The particular number and locations for such packages will be determined by the number and variety needed, and by considerations of clearance and access determined by location in a truss and other equipment and factors. Similar connectors can be accessed on or from multiple “faces” of the enclosure 450 to allow subsystems to be readily installed in different locations. Indeed, power and data busses can “circle” the enclosure and be available on some or all faces/sides.

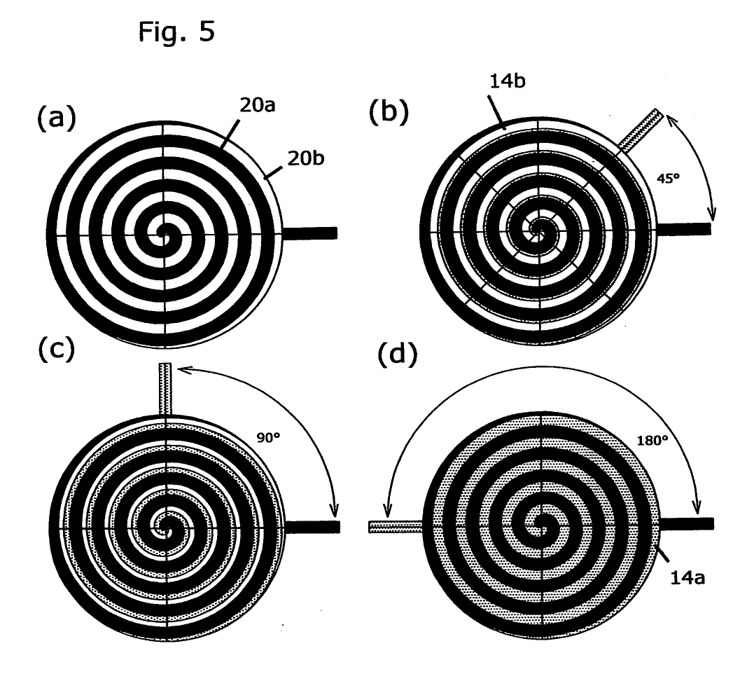

FIG. 13 is a “reverse plan” viewing the fixture of FIG. 12 from outside the truss envelope (typically from below) with the fixture head 460 retracted for shipping.

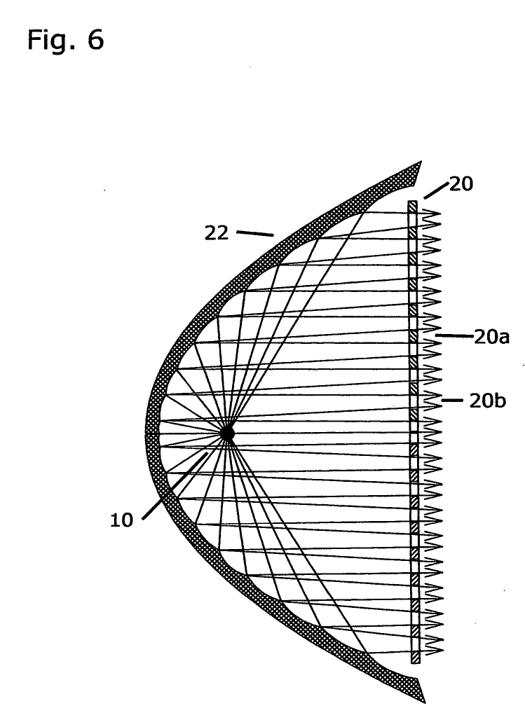

FIGS. 14-16 are section and plan views that illustrate variations in mounting bracket design with certain advantages.

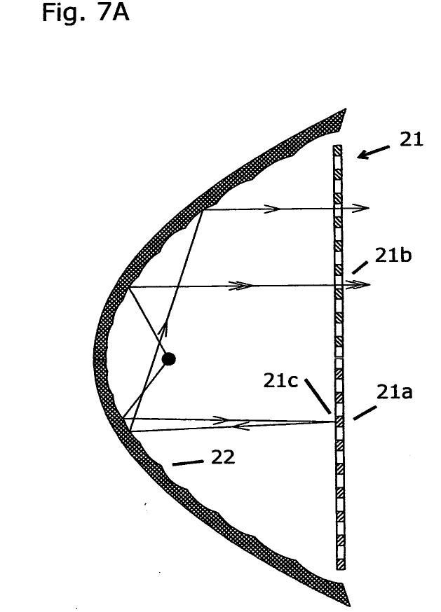

FIG. 15, for example, illustrates mounting brackets (e.g., 451F and 451G) that engage the low “rungs” or transverse chords of the truss (e.g., 450H). These brackets incorporate an offset that allow installing a series of enclosures in adjacent truss “bays” that are precisely aligned along the same elongated axis.

FIGS. 14-16 also illustrate alternate bracket designs for locations, like the end “bays” of a truss, where mounting brackets like 451F (or 452B) would be obstructed. Bracket 451E engages the low chord 400G and bracket 452E the upper chord 400E at a truss end, while extending neither substantially beyond the centerline of the truss nor beyond its end-wise face, such that conflicts with the truss-end structure and joining sections are avoided.

FIG. 15 also illustrates how the octagonal shape of housing 450 and the externally-mounted subsystems 455 cooperate to provide better access to the truss ends for joining.

By omitting subsystems 455 from faces 450J and 450M of enclosure 450, access to the truss end for bolting is improved. In fact, six of eight faces of the enclosure remain available for subassemblies.

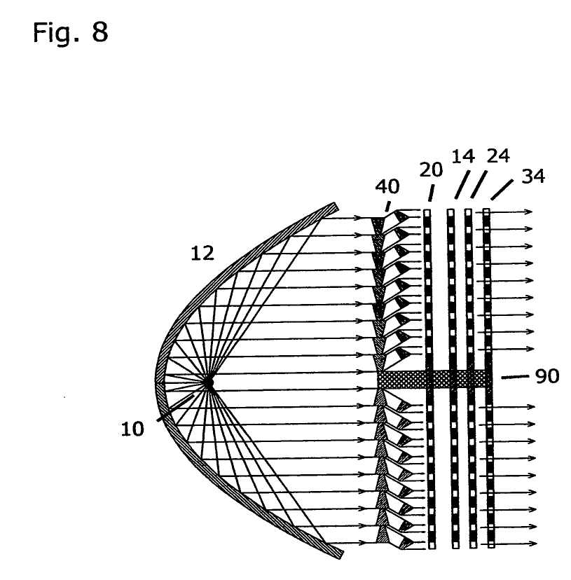

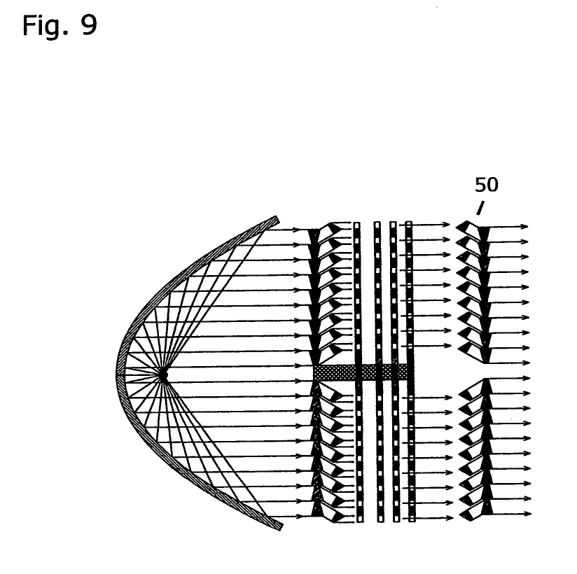

FIGS. 17 and 18 illustrate another format for packaging electronics (or other components). Package 456 extends into the region defined between the upper (e.g., 400F) and lower (e.g., 400H) transverse “rungs” of the truss structure. It provides considerably larger internal volume.

Other package designs (including the division of packages into fractional “heights”, such that one or more packages in fractional sections can be mounted on the same face of the enclosure) can be employed.

Other improvements relate to the distribution of power.

As has been described in prior applications, many lighting systems have required, for many years, the ability to distribute dimmed single-phase, un-dimmed single-phase, and un-dimmed multi-phase power, to various lighting and other loads.

To date, separate equipment has generally been employed for each purpose, with various drawbacks.

Prior applications by the applicant disclose methods and apparatus for providing one or more such required power types from more universal equipment.

The enclosed Figures illustrate embodiments of equipment serving the same or similar function(s).

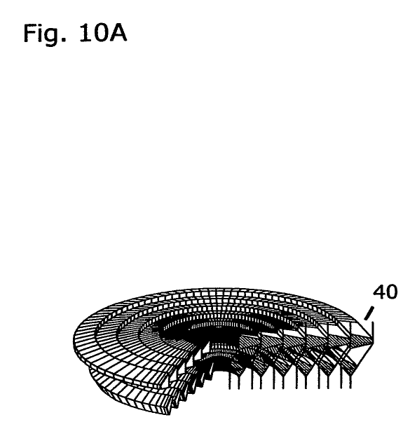

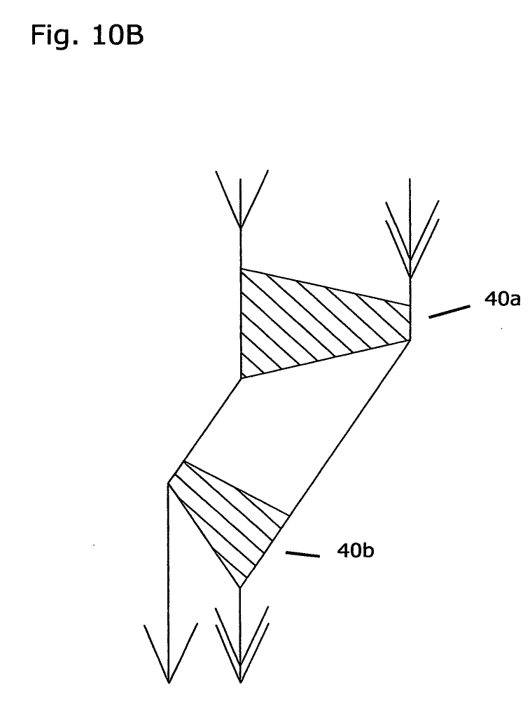

FIG. 20 illustrates some components of one possible embodiment in physical form. FIGS. 21-23 illustrate various embodiments in generalized schematic form.

Component 20 is associated with a power distribution function. As illustrated in FIGS. 21-23, component 20 accepts multi-phase power from busses 71N, 72X, 72Y, and distributes it to a plurality of output circuits of lower ampacity, via branch-circuit protection devices like circuit breaker 75a As previously described, there are applications (often within the same event, production, installation, or project) requiring dimmed, un-dimmed single-phase, and un-dimmed multi-phase power.

Component 20, in various embodiments in various Figures, is illustrated with provisions to supply both single- and multi-phase un-dimmed power. As such applications typically employ different connector types for single-circuit connections, various Figures illustrate one or more additional “output modules” 25, that mount the appropriate connector(s) on a module that plus into component 20, and is designed to connect the appropriate phase and neutral connectors as are required to produce the desired power configuration.

It will be seen, for example, that, in FIG. 21, the use of output module 25 will provide the L6-20 (or other) single-circuit connectors required in a multi-phase application and will couple those connectors (e.g., via contacts 84 and 85) to two different phases via double-pole circuit breaker 75a Alternatively, use of output module 25b provides known single-phase, single-circuit “stage pin” connectors (e.g., connector 26b) and will couple those connectors to one phase and neutral (e.g., via contacts 83 and 84). In single-phase applications, the second pole of a circuit-protection device like circuit-breaker 75a can be connected to a second single-phase connector (e.g., connector 26c). Therefore, twice the number of single-phase circuits/connectors can be supplied from the same number of double-pole branch circuit protection devices as double-pole circuits.

Whereas different types of single-pole connectors are typically employed for single- versus multi-phase circuits, it has been the practice to employ the same multi-connector (typically a 19-pin “Soco” connector) for multi-circuit multi-cables). In both applications, all odd-numbered pins from pin 1 to pin 11 are phases for an equal number (six) of circuits. Pins 13-18 are used for safety grounds. In single-phase applications, the even-numbered pins from 2-12 are used for neutrals; in multi-phase applications, for additional phases (each such phase differing from the next-lower pin/conductor to produce a 208-volt potential between the pair).

Therefore, if a power-distribution component provides such a multi-circuit connector, either different such connectors are required, one for each configuration or, alternatively, a single such multi-circuit connector can be employed and the function/connection of at least the six even-numbered pins that may be changed between neutrals and phases, depending upon the application/need.

FIG. 21 illustrates the output modules 25a and 25b as each also mounting such a multi-circuit connector. Such connectors are paralleled to the module inputs and the single-circuit connectors to provide the appropriate configuration.

In these and other embodiments, there may be a consideration as to a need for “common-throw”/“common-trip” operation of branch-circuit protection devices on multi-phase circuits. Where the same circuit includes a plurality of energized (phase) conductors, electrical code may require that a device used in circuit-protection and/or switching open all such energized conductors at once (such that “tripping” or manual switching of a given circuit to the “off” position cannot result in a potentially hazardous continued voltage potential beyond the switch or circuit-protection device. Typically, the multiple poles of a switch or circuit breaker are mechanically linked, such that use of an actuator handle or the “tripping” of one pole of a protection device will actuate all poles.

Where, as illustrated in FIG. 21, two poles of circuit protection device (e.g., circuit breaker 75a are used, either for two single-phase circuits or one multi-phase circuit, coordination of the operation of each pole is desired, when in the multi-phase mode.

Two poles/devices with permanently-coordinated operation can be employed. This approach is simple and economical, but has the drawback that, in single-phase circuit mode, switching or “tripping” of one circuit will affect both.

Coordination between two poles can be made provisional on multi-phase operation. For example, FIG. 21 illustrates a means 75T that coordinates both poles of circuit breaker 75a and is responsive to the choice of output module. Single-phase output module 25b, for example, is illustrated with a feature that does not actuate means 75T. Multi-phase output module 25a has no such recess and will actuate means 75p (which can be part or wholely mechanical or electronic). When means 75T is actuated, the operation of the two poles of circuit-breaker 75a are linked or coordinated. Thus, multi-phase operation, in requiring use of an output module with appropriate connectors, produces the required coordination.

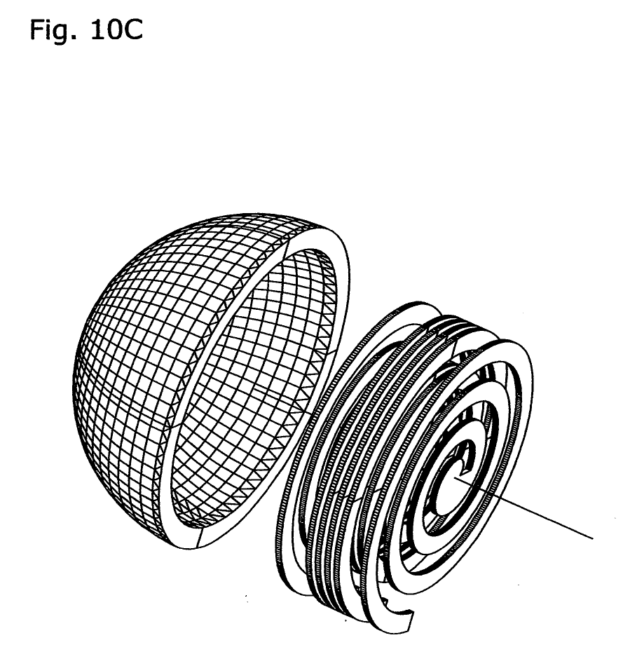

FIG. 22 illustrates another approach. In this variation, three poles of circuit-protection are provided. One pole, via single-pole device 75b And two poles, via two-pole device 75c , the two poles on different phases (although, as illustrated, one pole is on the same phase as the single-pole device 75b). All three poles are supplied to connector poles 84, 85, and 86. As will be seen, use of an output module 25c having a multi-phase application/connector results in connection of the output connector 26c to the two, coordinated poles of device 75c. Use of an output module 25d for single-phase operation results in the connection of the output connectors 26d and 26e to the un-coordinated poles of devices 75b and 75c.

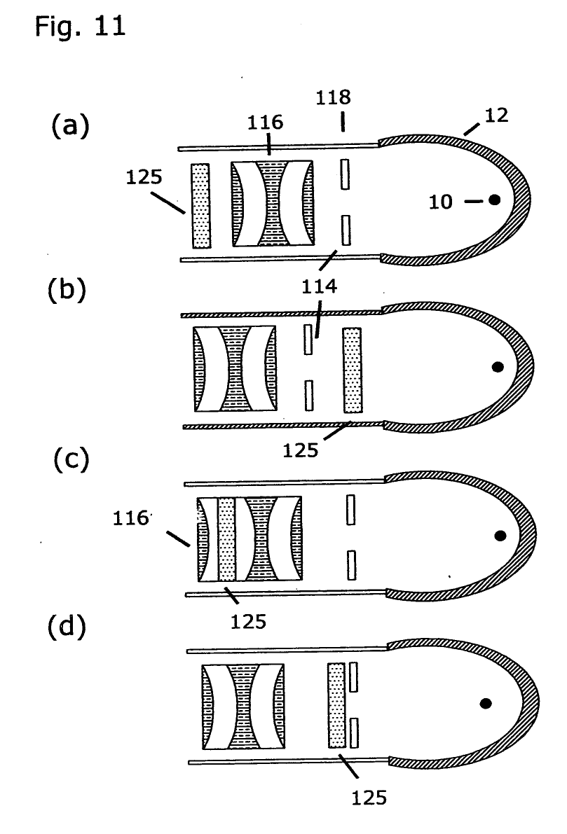

FIG. 23 illustrates one method of providing for the alternate configurations required of a multi-circuit connector in single-phase versus multi-phase applications.

FIG. 23 illustrates the use of output modules and as in the prior Figure. Multi-circuit connectors can be mounted on each such module, as was generally illustrated in FIG. 21, wired appropriately.

FIG. 23, however, illustrates the multi-circuit multi-connectors as being mounted separately, here on modules 27c and 27d Additional output connections (e.g., 86, 87, and 88) are illustrated on component 20. It will be seen that, like previously-described output modules, the choice of output module determines its connection to the various phases and to neutral available from component 20.

Output modules 27c and 27d are illustrated as having features (physical, mechanical, or electrical) that prevent their use in an incorrect configuration for the choice of mode as reflected in the choice of single-circuit connector output module employed. It will be seen that if single-phase single-circuit output connector module 25d is mated with component 20, that multi-phase, multi-circuit output connector module 27c cannot be mated with it.

Changes in the configuration of a multi-circuit multi-connector can be made by many means, including switch(s).

It will be seen from FIG. 23 that the same module might be inverted (or otherwise re-oriented or offset) in insertion, which would have the effect of changing the connection of the even-numbered pins.

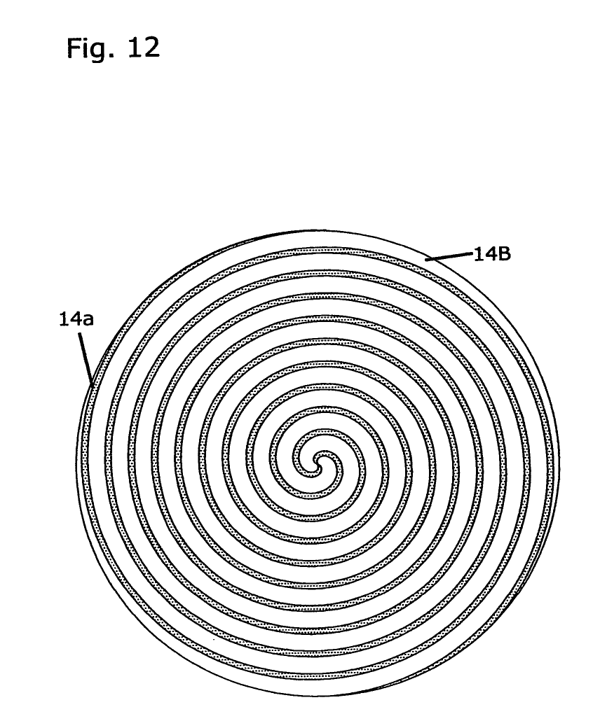

FIG. 24 is another view of an embodiment of an output module 25 that is mated with a power-distribution component 20, shown here in an un-mated, spaced-apart relationship.

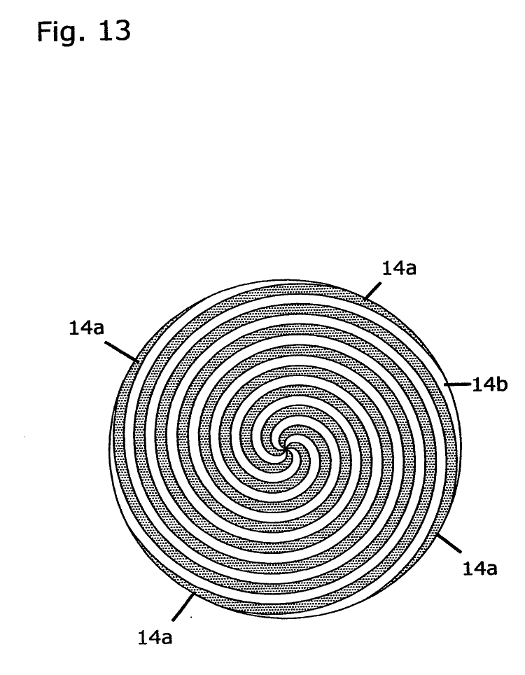

FIGS. 25D-25F illustrate several different variations on output modules differing in the connector type and whether a multi-circuit multi-connector is included.

Connections, such as 83-88, between a power-distribution component and an output module may be in the form of one or more connectors that mate with output module(s), but do not mate directly with the connectors typically used in lighting applications.

Alternatively, the power-distribution component 20 may employ output connectors that are compatible with both output modules and one or more connectors typically used in lighting applications, such that economies are achieved in certain modes or applications by permitting direct connection to the power-distribution component without the need of an output module.

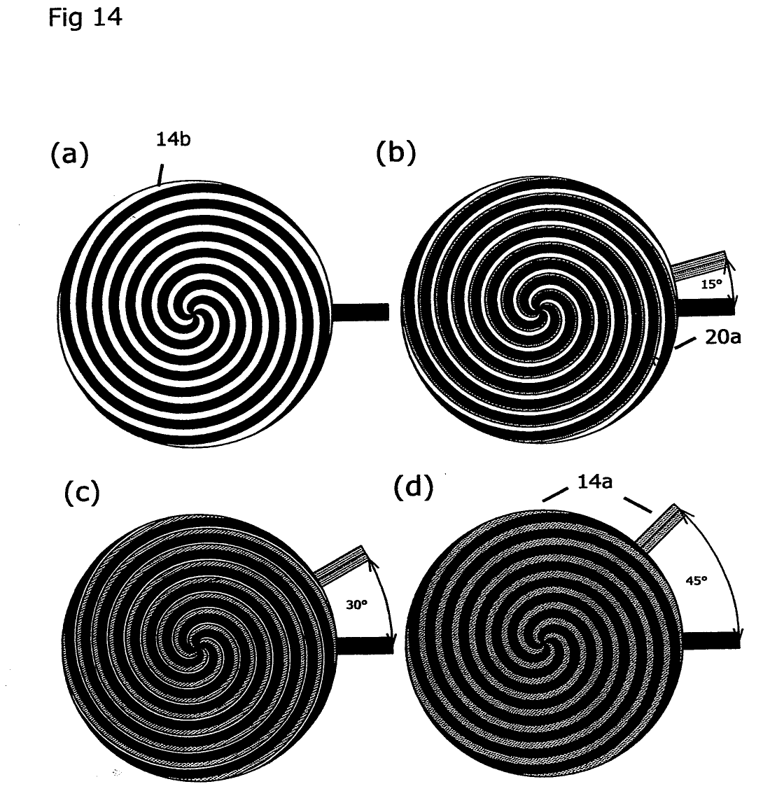

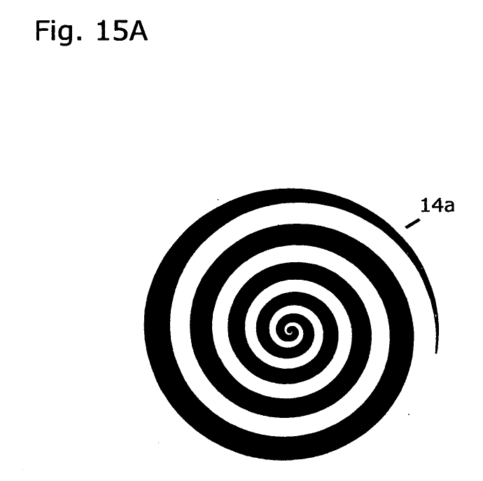

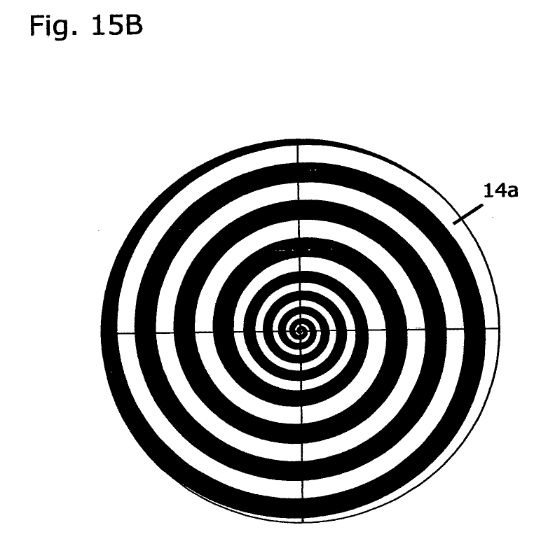

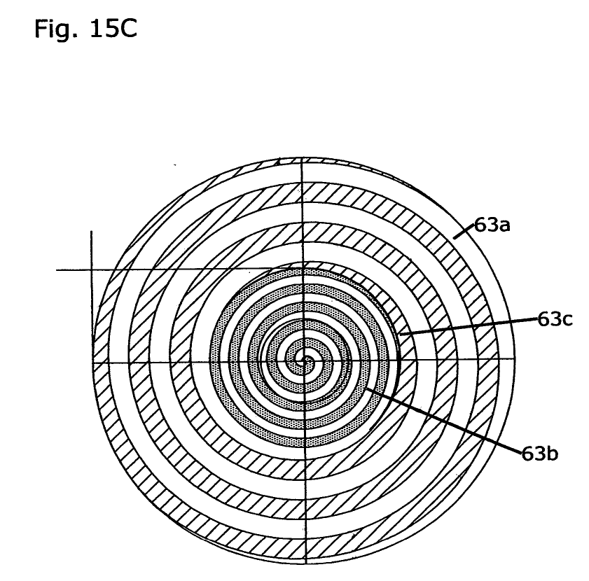

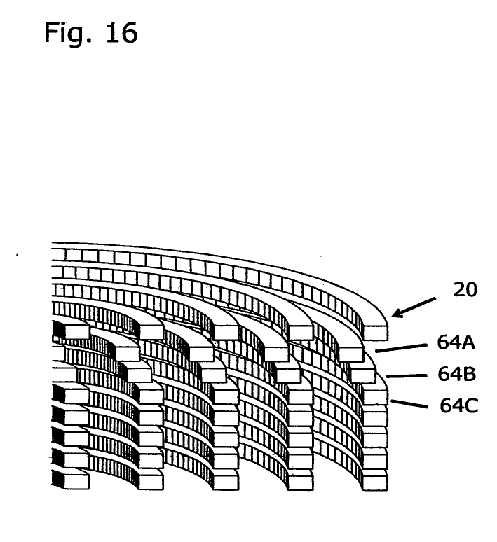

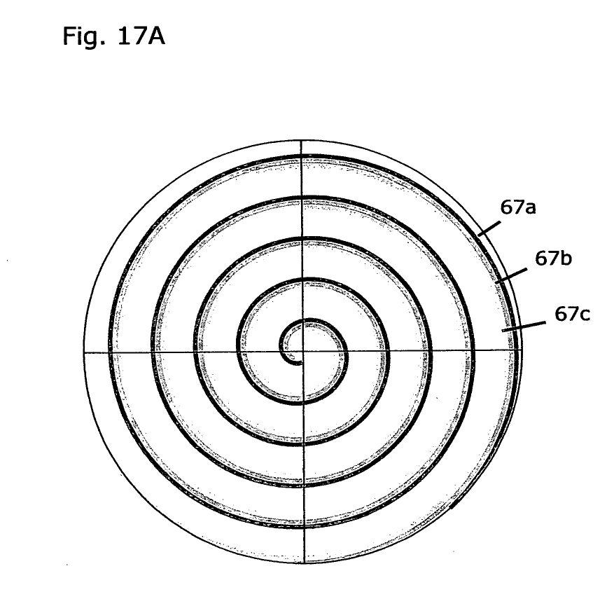

FIGS. 26A-26C illustrate a variety of connector configurations. FIG. 26A illustrates groups of four, paralleled, single-pole receptacles as are typically used in the “patch bays” of some dimmer racks to load-patch multi-circuit multi-connectors. FIG. 26C is a similar concept using “Power-Pole” brand connectors. FIG. 26B employs known 20A “stage pin” connectors. Such connectors can, themselves, be designed in the known manner, on replaceable panels or sub-panels to allow a manufacturer (or user) to configure different versions.

With the use of, for example, the “stage pin” connectors of FIG. 26B, an output module 25 could be configured with pins mating with such connectors. Where an additional function (for example “third pole” 86 is required for some output module configurations, additional poles could be provided on component 20 for such connections, while still preserving compatibility with known connectors.

Similarly, many alternatives are possible for providing input power to the power-distribution component. FIGS. 26A-26C, for example, illustrate three alternatives. FIG. 26A, for example, illustrates single-pole power inlet connectors; FIG. 26B a cable clamp for a flexible power cord; and FIG. 26C, larger versions of the same “Power-Pole” connectors used for outputs.

The paralleling of multiple distribution and/or dimmer units or “packs” on a larger service requires either the use of conductors and connectors having an ampacity suitable for the total supply, or requires the distribution of the total supply into a plurality of smaller sub-services, each sufficient for one such unit or “pack”, via fuses or circuit breakers sized for the smaller ampacity of the sub-service conductors and connectors.

Various Figures illustrate systems that allow the use of plural such units in a common enclosure via a common high-ampacity power bus system.

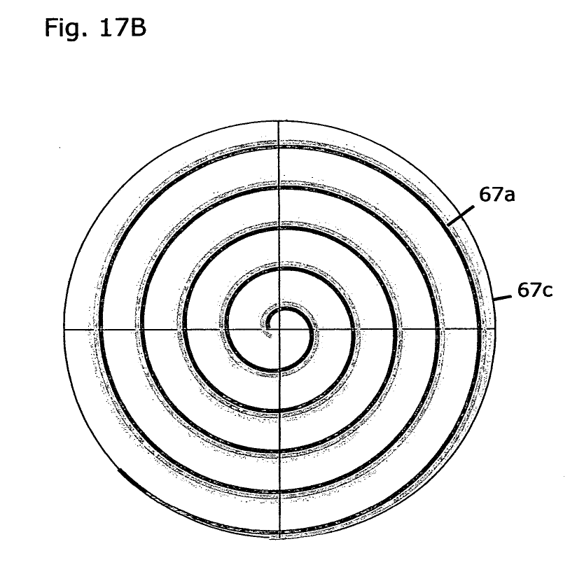

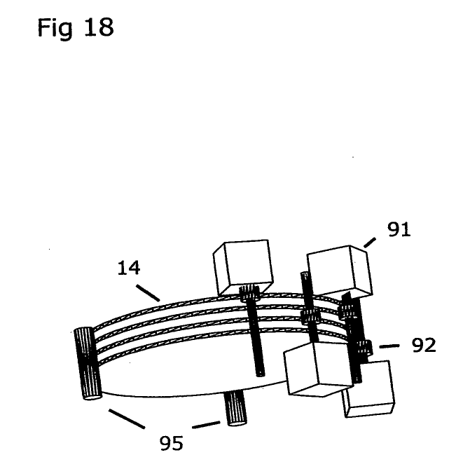

FIG. 27A is a plan view of one embodiment, comprising bus bars (e.g., 72ZC) that extend parallel to a plurality of power-employing/distributing units such as component 20. Connector 74D (seen in elevation 27B of the rear surface of a component 20) is mounted to component 20 and contains contacts that mate with the bus bars in the known manner. The bus bars and contacts are both shielded by non-conducting material that assists in their alignment in mating and reduces prospects of accidental contact when exposed.

Other Figures illustrate other embodiments for such high-current distribution.

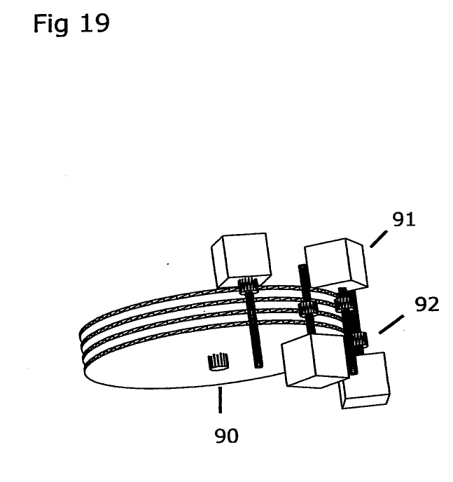

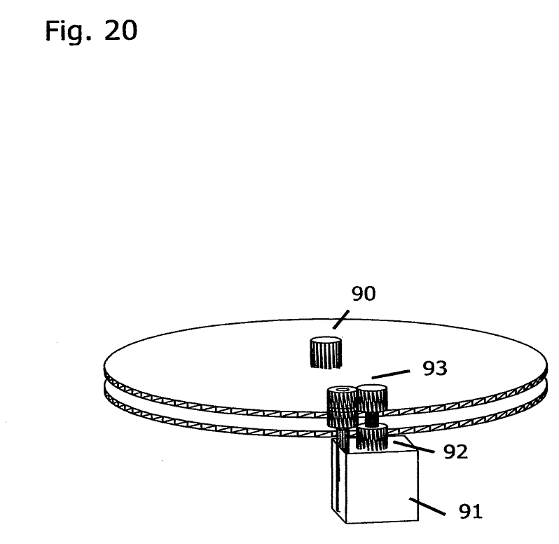

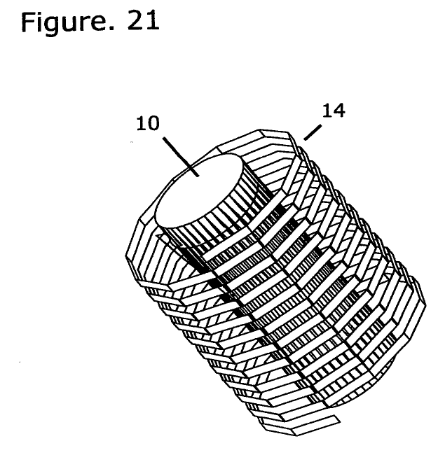

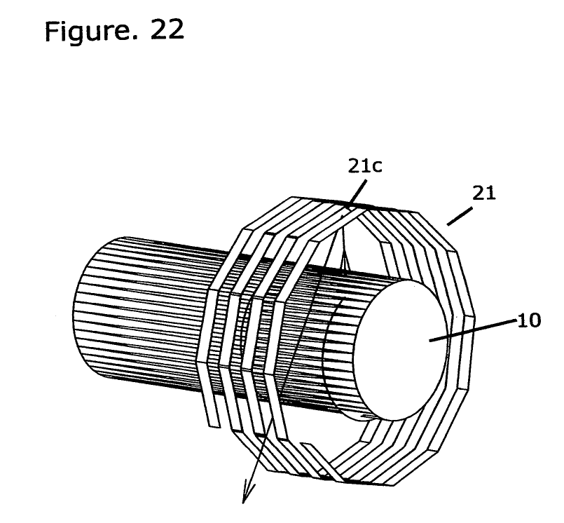

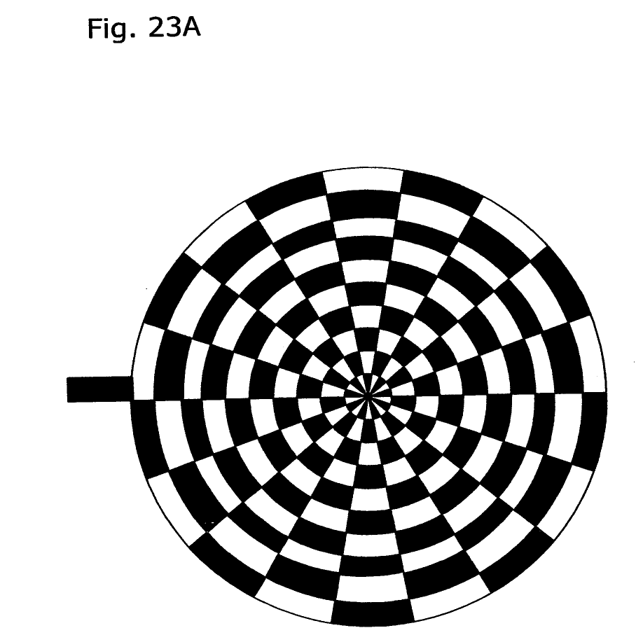

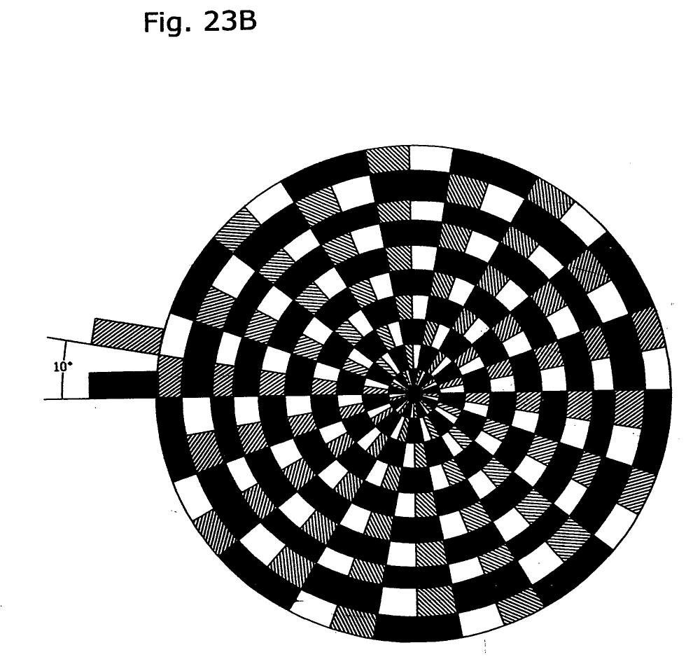

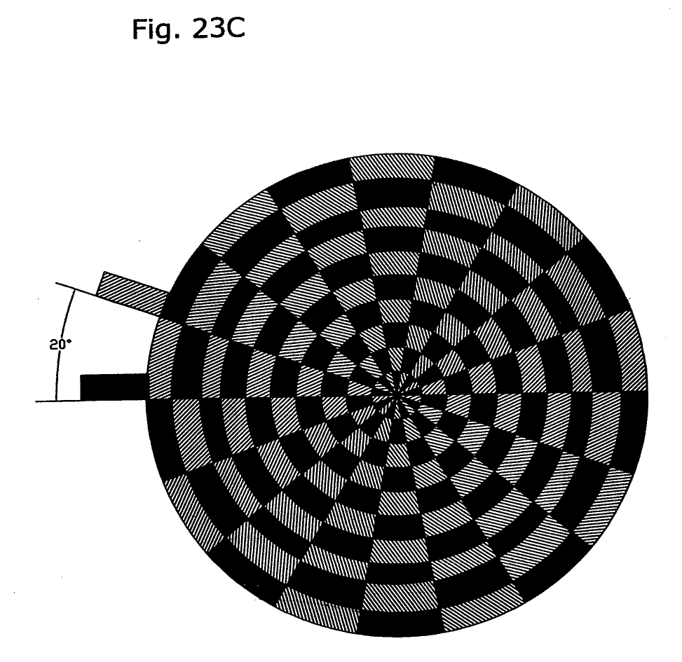

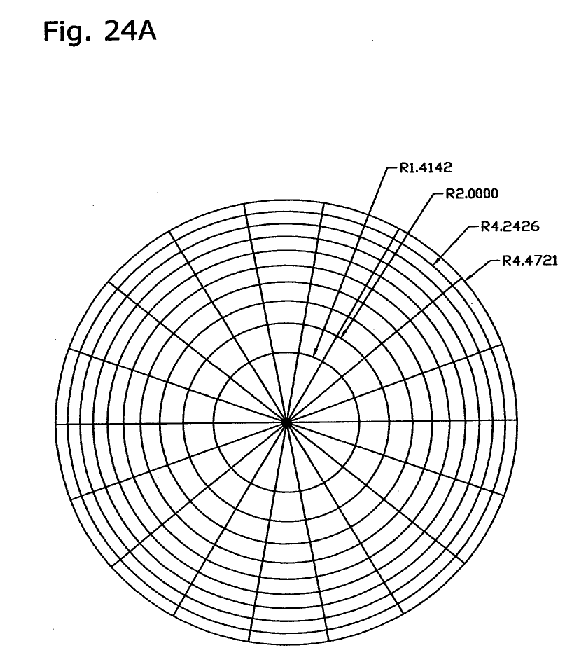

FIGS. 28A-28H, for example, illustrate a system employing bus bars (e.g., 74ZD) that are enclosed entirely within a non-conducting form 70D. As seen in FIGS. 28B and 28C, pass holes are provided in the non-conducting form 70D through which male pins on the components (seen in FIGS. 28D and 28E) can engage openings machined or formed in the buss bars serving as receptacles. Discrete receptacles can be installed in or attached to a bus bar. Adjacent connections are shown offset to increase clearances. While the mating pins are illustrated as generally cylindrical, other contact shapes (for example, rectangular) are possible. FIGS. 28G and 28H illustrate other methods of providing bus bars with areas that may be used as or accept components service as receptacles. In FIG. 28H, two parallel bars are separated by spacers. In FIG. 28G, bars are formed and combined in pairs to produce such areas and to make more efficient use of total cross-sectional area.

FIG. 28E illustrates such a power bus assembly before mating and FIG. 28F after mating. It will be seen that, in addition to supplying component 20 from one side, the assembly can supply another component, such as output module 25 from another side. In this case, output module 25 is supplied with neutral and ground connections directly from the power bus assembly, which can be of value in reducing the number and/or ampacity of connections for these purposes required via component 20. There are other contexts in which direct and/or two-sided access to a power bus is valuable.

Various Figures also illustrate the capability to provide a dimming function.

Various formats are possible.

A dimming capability, in the form of at least dimmer power stages, can be incorporated in component 20, either permanently, or in the form of plug-in modules.

Such dimmer power stages could be located in the current path of each relevant circuit, and their power devices locked in conduction (or bypassed) when un-dimmed power is desired.

Alternatively, such power stages can be packaged to be “pluggable” as needed, and to be electrically inserted in the relevant circuit, either as a direct result of the insertion of a power stage or another operation or feature. Various methods for doing so have been disclosed in prior applications.

Such power stages, or the provision to accept such power stages, can be incorporated in the basic power distribution component. FIG. 25, for example, illustrates a rack-mountable embodiment of a chassis 21 with both branch-circuit protection and provision for plug-in power stages (e.g., module 22).

However, in those applications in which un-dimmed power is required, the provision for power stages, even if only on an “on-demand” basis, brings with it certain costs in both the added components and the added volume required by such provisions.

Various Figures illustrate embodiments in which the provisions required to dim circuits are packaged in a separate modular enclosure that can be used or omitted as needed.

FIG. 20 illustrates one such embodiment. Component 20, as previously described, accepts multi-phase power and includes branch-circuit protection components for producing a plurality of single—and/or multi-phase circuits.

When component 20 is used only for un-dimmed circuits, top cover 20c is employed.

When dimmed circuits are (or might) be employed, then an additional component/enclosure that adds those components necessary can be added. Two alternatives are illustrated in FIG. 20; one component 31 that incorporates the power stages of multiple dimmers; and another 30, that provides for the use of plug-in modular power stages (e.g, 35). FIGS. 21-23 are also illustrative. Component 20 includes connector(s) 20C. Component 30 includes mating connector(s) 30C. When the power-distribution and a dimming component are used together, circuits, as necessary, are diverted through the dimming component. Such other provisions (reference neutral, earth ground, control and feedback signals, etc.) as necessary or desirable are also coupled.

FIGS. 21-23 also illustrate one of several embodiments, disclosed in detail in the prior application, that connects a power stage in circuit when inserted, and closes a shunt and completes the circuit when a power stage is not inserted. As disclosed in the prior application, other methods can be employed.

Similarly, circuits can be completed between the branch circuit protection devices (e.g., circuit breaker 75a and the output terminals (e.g., 84 and 85) of a power-distribution component when a dimming component is not used by any suitable means, including, but not limited to, shunting through connector 30C.

FIG. 20 illustrates the dimming component 30 or 31 as attaching to component 20 by replacing top cover 20c otherwise used on component 20. Other approaches, including mechanical independence and interconnection by means including rigid or flexible “couplers” or jumpers are possible.

The dimming component may have connectors on its surfaces.

Any suitable technology for the dimmer power stages may be employed. Some Figures illustrate plug-in modules that preferably employ “controlled-transition” technology as previously disclosed by the applicant and his co-inventors. Such technology has many advantages, including, by elimination of the need for a choke, the reduction in power supply size and weight to little more than required by its heat sink.

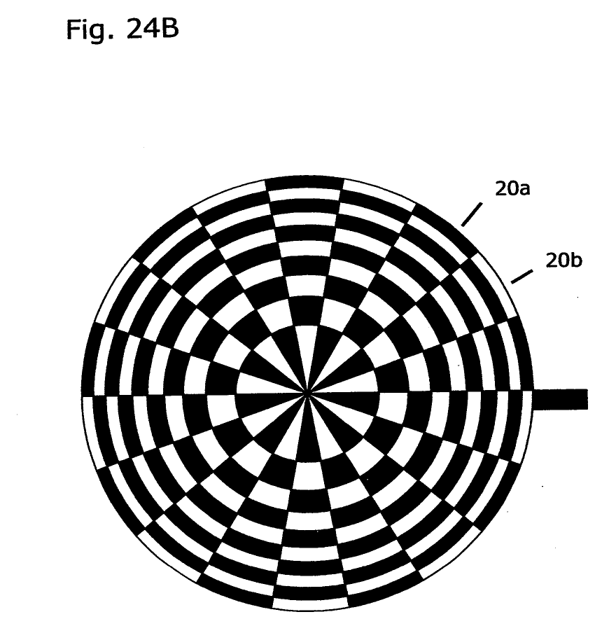

FIG. 29 illustrates that the same or similar power-stage package can be combined with branch-circuit protection devices in a common plug-in module.

In packaging any power stage in a module, it is desirable that it be useable in multiple applications. A compact module that integrates semiconductor devices in die or hybrid form with a heat sink (whether it includes an entire controlled transition power stage or just the thyristors and associated components of traditional choked dimmers) relies on forced airflow to dissipating its thermal load. Given the costs associated with such integration, it is desirable that such a compact module be useable in multiple applications. It is, therefore, desirable that means be provided to increase heat sink area to permit, in some cases, higher currents and/or longer rise times, and/or to reduce or eliminate the requirement for forced air flow.

One method of doing so it to mount the semiconductor components on a “base plate” that provides for connection with one or more additional heat sink parts, by means of a thermally-efficient interface.

Another method is to employ a basic heat-sink form and to provide for thermally connecting it with additional heat sinking part(s), as may be required or desired in the application.

Where dimming functions are provided in an additional enclosure, it will generally be in the interests of economy to incorporate the various components required for the dimming function in the additional enclosure. However, the power-distribution component may have unused internal volume into which portions of the dimming package can extend.

The dimming function also brings with it at least two control requirements.

One, of course, is the conversion of desired-intensity values into the desired firing-angle for the semiconductor power devices.

Another is the interface between each dimmer and a serial communications bus carrying such desired-intensity value. Associated with this function the user interface required to specify dimmer “address” (which of the many desired intensity values in the serial data stream (typically, DMX-512) to which each dimmer should respond).

Each function requires processor bandwidth, and the user interface requires displays and switches.

Lighting systems may require other functions, like optical-isolation/buffering of data links feeding dimmers, fixture accessories, and/or automated fixtures at various locations and down-converting higher-speed data streams.

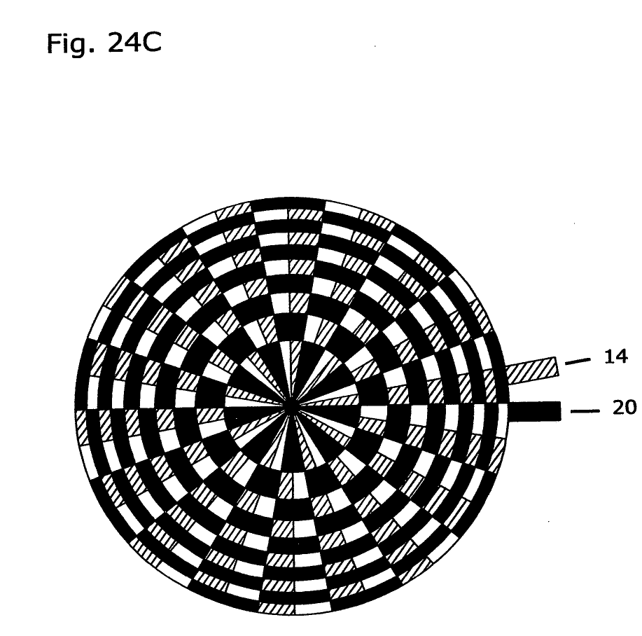

FIG. 30 illustrates various approaches to meeting these needs.

Where one or a few dimming units are used, a practical approach may be to provide each one with the capability of accepting and employing a data stream, as well as the user interface required for address-setting and other purposes. Where a large number of dimming units are used together, there may be advantages in sharing means for some functions. For example, in modern practice, racks of up to 96 dimmers can share a common serial interface and user interface module, which also performs all necessary firing-angle calculations, requiring no local intelligence in each dimmer module.

The system illustrated in FIG. 30 provides several alternative approaches.

Firing-angle calculations can be performed by each plug-in dimmer power stage module; or by a common control module 38 shared by all power stages in a chassis 30; or by a shared control unit 40 shared by multiple chassis and many dimmers. User interface displays and buttons can be provided at the chassis level (module 38) and/or at a shared control unit 40. A shared control unit, in any embodiment, can provide functions including opto-isolation and down-conversion.

Other improvements are, in one embodiment, used to motorize certain adjustments to fixtures often used in television and film applications, such as halogen and HMI-source fresnel and “PAR” fixtures. Where such fixtures had previously been manually-adjusted, requiring access by a worker, they can be motorized for remote adjustment with many advantages.

One aspect of motorizing such fixtures is the massive inventory of units not designed with or for motorization.

It is advantageous, therefore, to provide a “motorized yoke” that accepts one or more model of existing fixture.

Such yoke can attach directly to the fixture head, in lieu of the simple yoke provided with the fixture.

Such, replacement, motorized yoke can provide not only motorized adjustment of pan and tilt, but employ mechanics having greater economy, simplicity, and/or stability than would the motorization of a yoke similar to the typical un-motorized version. For example, the “pan” pivot function can be provided by a relatively large “lazy susan”/circular bearing, rather than the traditional single-point pivot.

In many such applications, a “barndoor” is employed to shape the beam, such “barndoor” being retained and rotated in brackets or “gel clips” located at the fixture's beam exit. Where such barndoors (or an equivalent) are motorized, they may be preferably attached to a forward bulkhead that is, itself, attached to the motorized yoke and not to the fixture itself. Such bulkhead can be adapted to hinge or otherwise move away when an existing fixture requires re-lamping by hinging its lens/front door open for access to the lamp and socket.

In large fixtures of this type, power for the actuators can be provided independently or can be derived from power supplied to the fixture's lamp. In the case of high-current halogen lamps, they are traditionally supplied by flexible single-conductors and single-pole connectors. In addition to direct connection to such supply, such conductor(s) can be passed through coils similar to those employed for current-sensing. Such a method for deriving power for actuators and local electronics is often simpler and more economical than paralleling with high-current conductors and connectors and provides useful isolation.

It will, often, be desirable to provide remote control of motorized parameters by wireless means.

Other improvements relate to folded optical paths.

In one example, a light source is disposed in a fixture. A hemispherical (or other) reflector, disposed “forward” of the light source in the housing, redirects rays emanating from the source in a “forward” direction back through the source. Rays from the source either emanating directly from the source in a zone behind perpendicular to the fixture/source centerline as well as those redirected through the source by the forward hemispherical (or other) reflector emanate “outwards”, where they encounter an annual reflector that can direct such rays “forwardly” towards an exit. Rays forward of this annular reflector initially form an annular luminous form that may remain so, or may be converged into a common form. Additional optical elements and/or parameter-modification features can be disposed in either or both forms.

Rays emanating from the source “backwards” at angles close to the centerline behind the source proper can be directed towards the annular reflector by one or more reflectors or other elements inside, integral with, applied to, and/or outside the source's envelope, whether directly and/or by way of the “forward reflector”.

Redirection of rays by the “forward reflector” back through the source may have some losses and might, in some applications, (despite use of a “cold mirror” coating on the forward reflector, increase thermal load on the source envelope. The “forward reflector” can also comprise a shape directing rays incident towards the annular reflector without passing through the source, for example, a conic reflector (with or without a curved reflector surface) having its apex towards the source.

Another folded system employs an effective source that is annular (in one example, a series of smaller point sources or a linear (e.g., gas discharge) source disposed in an annular reflector or an annular ring of sources (e.g., an array of LEDs) that direct output “back” in the fixture/system, towards an annular reflector (or other optical element) that re-directs the rays “inwards” towards the system centerline. There, another element, including, but not limited to a reflector of generally conic section (with or without curved surfaces) with apex “forward” folds the rays bent by the annular reflector or element into a common beam/form directed forwardly towards an exit. Additional optical elements and/or parameter-modifying components can be included in the path at any point.

Alternatively, the light source(s) can be disposed in an annular ring that directs their output “inwardly” towards a reflector or other optical element that directs them along a common axis, including in a common form/beam.

Another optical system is applicable to the use of large numbers of individual sources, such as LEDs. For purposes of increasing intensity and/or the area/beam angle illuminated, it is known to use a number of such LED (or other) sources in a common array, for purposes including, but not limited to, task lighting. Issues include uneven distribution, array size, and glare from the array.

Alternatively, a plurality of such sources can be disposed in a planar, curved, or other relationship, and each angled towards a nearby aperture. The size and shape of the aperture can be determined by factors including the beam angle of each source and the distance from source to aperture. Preferably, the useful region of the beam of such sources will be not substantially larger than the angle subtended by the aperture if losses are to be minimized.

Aligning a plurality of such individual sources with an aperture in this manner has many benefits.

The aperture becomes a virtual “point source”, such that shadows thrown by the plural sources have the singularity of a more conventional single source.

As the output of all such sources crosses through the same aperture, parameter-modifying means including optics, diffusion, color, etc. little larger than the aperture can be employed.

The aperture also reduces or eliminates glare from the sources and can present a more attractive aspect.

Sources can be strictly linear or in an X/Y arrangement. Apertures can be relatively compact or linear. Multiple apertures and/or arrays of multiple assemblies and apertures can be employed.

What is claimed is:

1. Apparatus for supplying power to lighting fixtures, said apparatus including:
a base unit, said base unit accepting a multi-phase power input and supplying a plurality of power outputs;
said power outputs being suitable for supplying loads including lighting fixtures;
said base unit providing for the addition of a dimming accessory;
said dimming accessory providing for the selective insertion of one or more power stages, each of said power stages being capable of varying that portion of the available power from said power input supplied to a corresponding power output.

2-3. (canceled)
